(19) United States
(12) Patent Application Publication
(10) Pub. No.: US 2011/0010172 A1
(43) Pub. Date: Jan. 13, 2011

(54) NOISE REDUCTION SYSTEM USING A SENSOR BASED SPEECH DETECTOR

(76) Inventor: Alon Konchitsky, Santa Clara, CA (US)

Correspondence Address: STEVEN A. NIELSEN;ALLMAN & NIELSEN, P.C., 100 Larkspur Landing Circle, Suite 212, LARKSPUR, CA, 94939, US

(21) Appl. No.: 12/833,918

(22) Filed: Jul. 9, 2010

Related U.S. Application Data
(60) Provisional application No. 61/224,643, filed on Jul. 10, 2009.

(51) Int. Cl. G10L 15/20

(52) U.S. Cl. 704/233; 704/E15.039

(57) ABSTRACT

Speech detection is a technique to determine and classify periods of speech. In a normal conversation, each speaker speaks less than half the time. The remaining time is devoted to listening to the other end and pauses between speech and silence. The classification is usually done by comparing the signal energy to a threshold. Classifying speech as noise and noise as speech may affect the performance of the communication device. The current invention overcomes such problems by utilizing an alternate sensor signal indicating the presence or absence of speech. In the current invention, the communication device receives an audio signal via single or multiple microphones. The speech sensor may generate a unique signal based on the facial, bone, lips and/or throat movements. The system then combines the information received by the microphones and the speech sensor to decide the presence or absence of speech. This decision can be used in the coding, compression, noise reduction and other aspects of signal processing.

### RELATED PATENT APPLICATION

The application claims the benefit, priority date and contents of U.S. patent application No. 61/224,643 filed on Jul. 10, 2009 and entitled “Noise Reduction System Using a Sensor Based Speech Detector” the contents of which are incorporated herein by reference.

### FIELD OF THE INVENTION

The present invention relates to means and methods of speech detection using single or multiple microphone(s) in combination with a speech sensor to detect the presence or absence of speech.

This invention is in the field of processing signals in cell phones, Bluetooth headsets, VoIP phones, wireless devices and any communication device in general. In general, it more relates to any device which needs to detect the presence or absence of speech particularly in a noisy environment.

### BACKGROUND OF THE INVENTION

Voice communication devices such as cell phones, wireless phones, Bluetooth headsets etc have become ubiquitous; they show up in almost every environment. They are used at home, office, inside a car, a train, at the airport, beach, restaurants and bars, on the street, and almost any other venue. As might be expected, these diverse environments have relatively high and low levels of background, ambient, or environmental noise.

For example, the background noise is significantly high in a crowded restaurant as compared to a quiet home. If this noise, at sufficient levels, is picked up by the microphone, the intended voice communication degrades and uses up more bandwidth or network capacity than is necessary, especially during non-speech segments in a two-way conversation when a user is not speaking.

For a stress-free communication, background noise has to be reduced. Speech detection is the core of any noise cancellation system. It is the art of detecting the presence of speech activity in noisy audio signals in a communication system. In speech recognition applications, the performance is severely degraded if noise is detected as speech.

Noise suppression systems have evolved over the years. Most of them are based on single microphone spectral subtraction technique described in “Suppression of acoustic noise in speech using spectral subtraction”, S. F. Boll IEEE Trans. Acoustics, Speech, and Signal Processing, vol. 27, no. 2, pp. 113-120, 1979. Speech detection is used in many signal processing systems for telecommunications. For example, in the Global System for Mobile communications (GSM), traffic handling capacity is increased by having the speech coders employ speech detectors as part of an implementation of the Discontinuous Transmission (DTX) principle, as described in the GSM specifications.

When speech is absent, noise is estimated and adapted. During a normal telephone conversation, each subscriber speaks less than 50% of the time during the connection. The remaining 50% is allocated for listening, gaps between words, syllables, and pauses.

Unfortunately, speech detection is not straightforward. In general, speech signal energy is calculated over short durations of time. The measured energy is then compared with a pre-specified threshold level. A zero crossing detector can also be used. The zero crossing rates are compared to a pre-defined threshold. The audio signal is said to be speech if the measured energy exceeds the threshold, otherwise the duration is declared to be noise or non-speech. The problem lies with the threshold determination due to the fact that different speakers usually speak at different levels in different environments. In addition, improperly classifying speech as noise and noise as speech will adversely affect the performance of a communication system.

A crucial component for a successful background noise reduction algorithm is robust speech detection technique. An objective of the present invention is to provide for an improved speech detection process with adaptive thresholds and to provide means for detecting low level speech activity in the presence of high level background noise.

Attempts to solve this problem have largely been unsuccessful. U.S. Pat. No. 7,120,477 B2 assigned to Huang discusses a personal mobile computing device for improving speech recognition. However, this approach uses a microphone (placed on rotatable antenna). The microphone is directed towards the mouth of the user.

U.S. Pat. No. 7,383,181 B2 assigned to Huang et al discusses using a sensor to detect the movement of jaw, face, muscles etc to separate speech and non-speech regions. However, the invention uses a boom microphone with a thermistor placed in the breath stream to sense the change in temperature.

Another patent US 2006/0079291 assigned to Granovetter et al uses a proximity sensor on a mobile phone to detect speech and non-speech regions. However, the proximity sensor consists of a soft, medium filled (with fluid or elastomer) pad designed to contact the user when the user places the phone against their ear.

Some of the other techniques include placing a bone conduction sensor which is pressed into contact with the skin. This setup detects vibrations in the bone. Such systems, however, can be irritating to the user, because of this contact and can be uncomfortable to wear for long durations. If the bone conduction sensor does not contact with the skin, the performance of the system is highly compromised.

### SUMMARY OF THE INVENTION

The current invention relates to speech detection and noise cancellation. Specifically, the current invention relates to capturing and analyzing multi-sensory input signals and generating an output signal indicating the presence or absence of speech. It provides a novel system and method for monitoring noise in an environment in which a device is operating and detects the presence or absence of speech in noisy environments. This detection is done using the information from single microphone or multi-microphones and a speech sensor which tracks the movement of human tissues, bones, throat, lips etc in the face.

The present invention employs an adaptive system that is operable in high noise conditions. By monitoring the ambient or environmental noise in the location in which the cellular telephone is operating via analog and/or digital signal processing, it is possible to significantly increase the channel bandwidth by identifying the idle regions in a conversation.

In one aspect of the invention, the invention provides a system and method that enhances the convenience of using a cellular telephone, Bluetooth headset, VoIP phone or other wireless telephone or communications device, even in a location having relatively loud ambient or environmental noise.

In another aspect of the invention, the invention provides a system and method that effectively separates the speech and noise regions before the signal is transmitted to the other party.

In yet another aspect of the invention, the proposed system increases the channel bandwidth by effectively identifying the idle regions in a typical conversation.

These and other aspects of the present invention will become apparent upon reading the following detailed description in conjunction with the associated drawings. The present invention overcomes shortfalls in the related art. Economies in hardware and power consumption are obtained. These modifications, other aspects and advantages will be made apparent when considering the following detailed descriptions taken in conjunction with the associated drawings.

### BRIEF DESCRIPTION OF THE DRAWINGS

FIG. 1a is a perspective view of one embodiment of the current invention where the communication device is held on the user's left ear.

FIG. 1b shows various embodiments of the current invention.

FIG. 1c shows the general block diagram of a microprocessor system.

FIG. 2 shows an application of the current invention in a Bluetooth headset.

FIG. 3 shows an application of the current invention in a cell phone.

FIG. 4 shows an application of the current invention in a cordless phone.

FIG. 5 is a diagram of an exemplary embodiment of the proposed system which utilizes information from a speech sensor and a single or multiple microphone setups.

FIG. 6 is a diagram of an exemplary embodiment of the proposed system which uses two sensors for information and suppresses the background noise.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

The present invention provides a novel and unique background noise or environmental noise reduction and/or cancellation feature for a communication device such as a cellular telephone, wireless telephone, cordless telephone, Bluetooth headsets, recording device, a handset, and other communications and/or recording devices. While the present invention has applicability to at least these types of communications devices, the principles of the present invention are particularly applicable to all types of communication devices, as well as other devices that process or record speech in noisy environments such as voice recorders, dictation systems, voice command and control systems, and the like.

For simplicity, the following description employs the term “telephone” or “cellular telephone” as an umbrella term to describe the embodiments of the present invention, but those skilled in the art will appreciate the fact that the use of such “term” is not considered limiting to the scope of the invention, which is set forth by the claims appearing at the end of this description.

Hereinafter, preferred embodiments of the invention will be described in detail in reference to the accompanying drawings. It should be understood that like reference numbers are used to indicate like elements even in different drawings. Detailed descriptions of known functions and configurations that may unnecessarily obscure the aspect of the invention have been omitted.

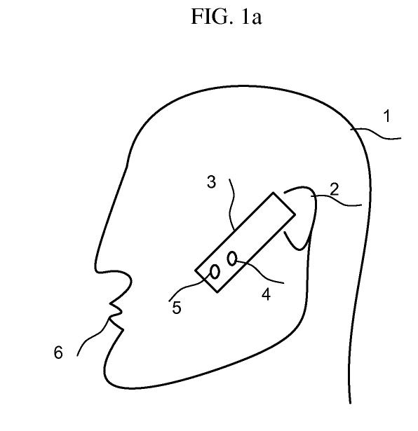

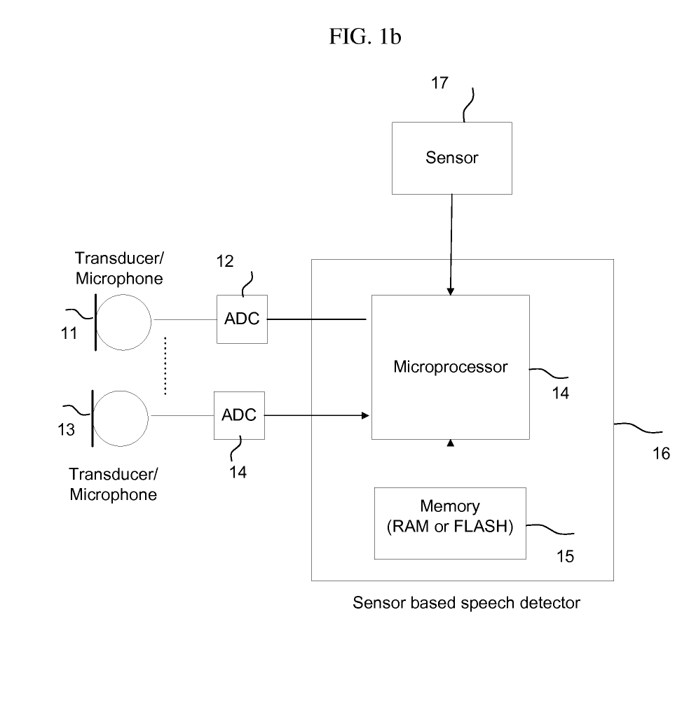

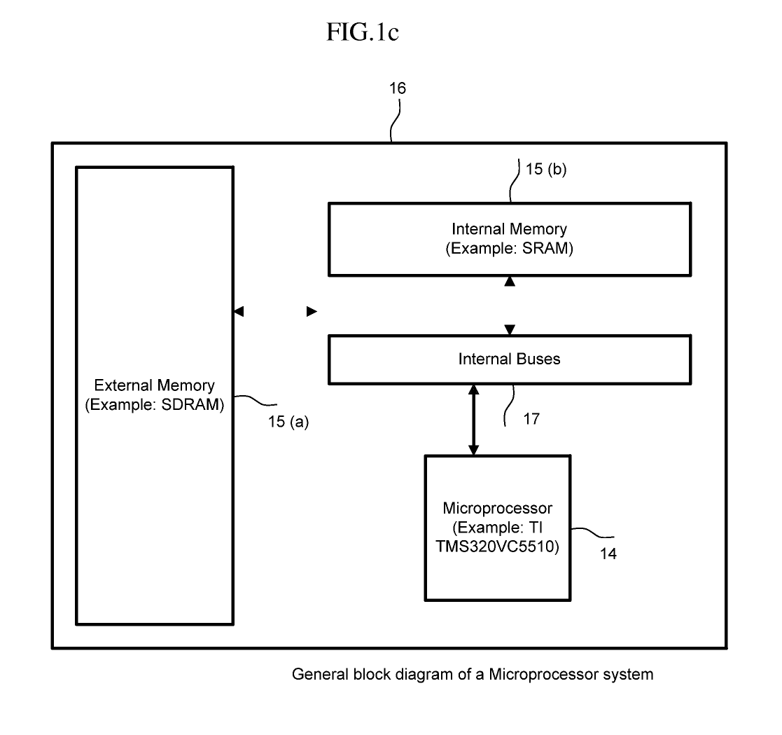

FIG. 1a is a perspective view of one embodiment of the current invention where the communication device is held adjacent to the user's left ear.

FIG. 1b shows various embodiments of the sensor based speech detector as described in the current invention. The transducer/microphone, 11, of the communication device, picks up the analog signal. The communication device can have single microphone or N microphones, where N is greater than 1. The Analog to Digital Converter (ADC), block 12, converts the analog signal to digital signal. The digital signal is then sent to the sensor based speech detector, block 16. In general any communication signal received from a communication device, in its digital form, is sent to the sensor based speech detector, block 16, which consists of a microprocessor, block 14 and a memory, block 15. The microprocessor can be a general purpose Digital Signal Processor (DSP), fixed point or floating point, or a specialized DSP (fixed point or floating point).

Examples of DSP include Texas Instruments (TI) TMS320VC5510, TMS320VC6713, TMS320VC6416 or Analog Devices (ADI) BF531, BF532, 533 etc or Cambridge Silicon Radio (CSR) BlueCore 5 Multi-media (BC5-MM) or BC7-MM or BC3. In general, the WNCM can be implemented on any general purpose fixed point/floating point processor or a specialized fixed point/floating point DSP.

The memory can be Random Access Memory (RAM) based or FLASH based and can be internal (on-chip) or external memory (off-chip). The instructions reside in the internal or external memory. The microprocessor, in this case a DSP, fetches instructions from the memory and executes them.

FIG. 1c shows the embodiments of block 16. It is a general block diagram of a DSP system where sensor based speech detector is implemented. The internal memory, block 15 (b) for example, can be SRAM (Static Random Access Memory) and the external memory, block 15 (a) for example, can be SDRAM (Synchronous Dynamic Random Access Memory). The microprocessor, block 14 for example, can be TI TMS320VC5510. However, those skilled in the art, can appreciate the fact that the block 14, can be a microprocessor, a general purpose fixed/floating point DSP or a specialized fixed/floating point DSP.

The internal buses, block 17, are physical connections that are used to transfer data. All the instructions required by the sensor based speech detector reside in the memory and are executed in the microprocessor.

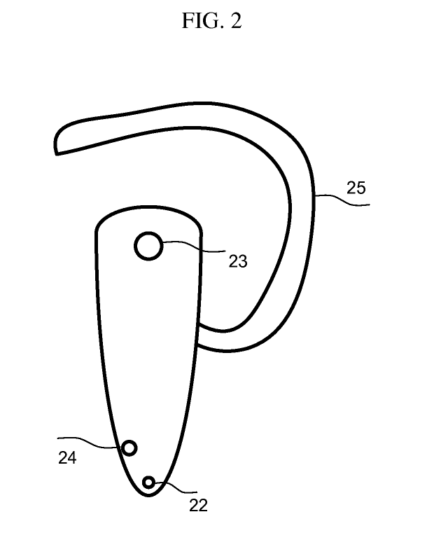

FIG. 2 shows a Bluetooth headset with sensor based speech detector. In FIG. 2, 22 is the microphone of the device. 23 is the speaker of the device. 21 is the ear hook of the device. Block 24 is the sensor which detects the presence or absence of speech.

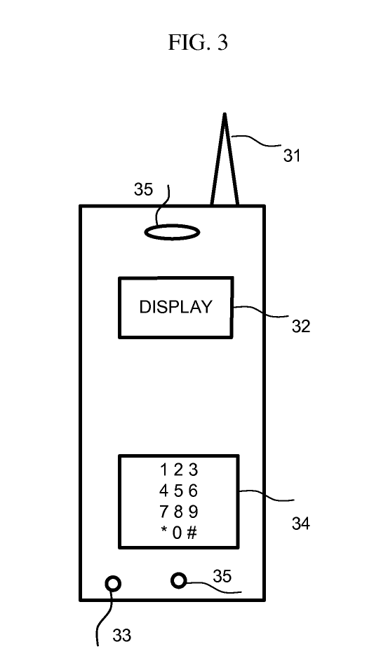

FIG. 3 shows a cell phone with sensor based speech detector. In FIG. 3, 31 is the antenna of the cell phone, 35 is the loudspeaker. 36 is the microphone. 32 is the display, 34 is the keypad of the cell phone. Block 33 is the sensor which detects the presence or absence of speech. The sensor can also acts as an optic sensor acting as transducer that translates mouth/chick/skin vibrations to voice signal.

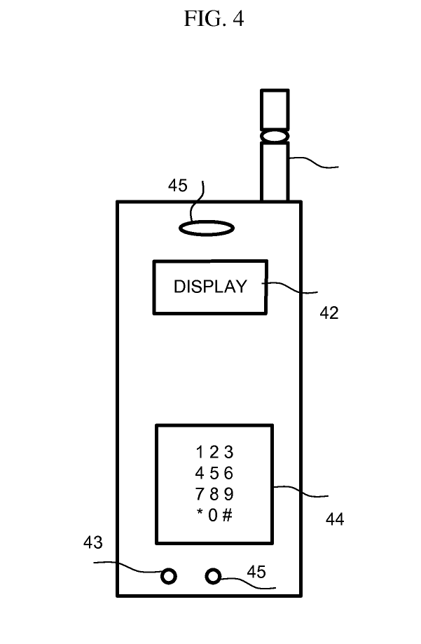

FIG. 4 shows a cordless phone with sensor based speech detector. In FIG. 4, 41 is the antenna of the cell phone, 45 is the loudspeaker. 46 is the microphone. 42 is the display, 44 is the keypad of the cell phone. Block 43 is the sensor which detects the presence or absence of speech. The sensor can also acts as an optic sensor acting as transducer that translates mouth/chick/skin vibrations to voice signal.

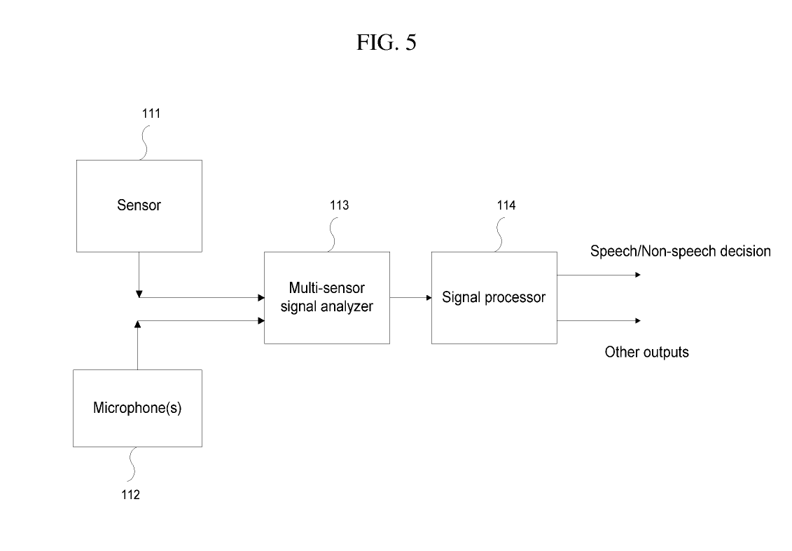

In FIG. 5, block 111 is the sensor which tracks the movement of the lips, neck, jaw, facial tissues and other body parts. Block 112 is the regular microphone. It can be a single or multiple microphone setups. The signals from sensor 111 and microphone setup 112 are sent to the signal analyzer, 113. Block 114 is a digital signal processor which analyzes the signals and makes a decision if the incoming audio signal is speech or non-speech. The sensor can also acts as an optic sensor acting as a transducer that translates mouth/chick/skin vibrations to voice signal.

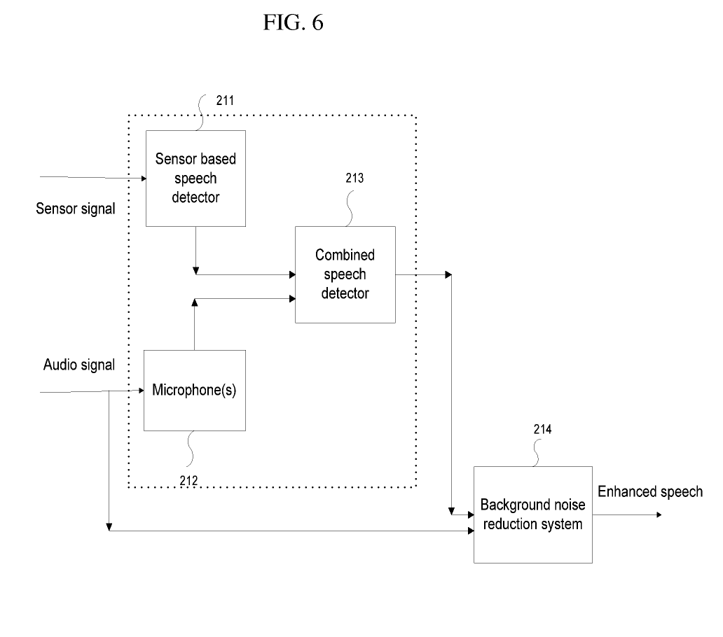

In FIG. 6, block 211 is the sensor based speech detector. Block 212 is the regular audio microphone which picks up the analog audio signals. Both the signals are combined in block 213 and a decision is made about the audio signal. In block 214, the background noise is removed with digital signal processing technologies to produce an enhanced speech.

Embodiments of the invention include but are not limited to the following items:

1. A system comprising,
a) a sensor for collecting information regarding the person being in a state of talking or not talking, and providing the information to a signal analyzer;
b) one or more microphone transducers, generating surrounding noise and voice signals to the signal analyzer;
c) the signal analyzer providing the noise and voice signals to a processing unit; and
d) the processing unit providing indications of periods of speech and non-speech based upon the inputs from the sensor and one or more microphones.
   2. A system comprising:
a) a sensor collecting voice vibrations and other input from a speaking person;
b) a microphone system, having one or more microphones collecting surrounding noise and voice signals and provide such signals to a combined speech detector;
c) the combined speech detector getting input from the sensor based speech detector and the microphone system and the combined speech detector determines the presence or absence of speech and send a speech or noise determination to a processing system; and
d) the processing system receives input from the microphone system and a speech or noise determination input from the combined speech detector, the input from the microphone system is processed to the speech signal.
   3. The system of item 2 wherein the microphone system and speech detector are integrated into a headset to improve the signal to noise ration of a transmitted signal from the headset.
   4. The system of item 2 with the sensor receiving input from movement of a person's jaw.
   5. The system of item 2 with the sensor receiving input from movement of a person's throat.
   6. The system of item 2 with the sensor receiving input transmitted from facial movement.
   7. The system of item 2 wherein a person's biological vibrations are used to determine periods of speech.
   8. The system of item 2 wherein a person's face vibrations are used to determine periods of speech.
   9. The system of item 2 wherein a person's jaw vibrations are used to determine periods of speech.
   10. The system of item 2 wherein a person's head vibrations are used to determine periods of speech.
   11. The system of item 2 wherein a person's face vibrations are used to capture speech.
   12. The system of item 2 wherein a person's jaw vibrations are used to capture speech.
   13. The system of item 2 wherein a person's head vibrations are used to capture speech.

As described hereinabove, the invention, sensor based speech detector, has many advantages. While the invention has been described with reference to a detailed example of the preferred embodiment thereof, it is understood that variations and modifications thereof may be made without departing from the true spirit and scope of the invention. Therefore, it should be understood that the true spirit and the scope of the invention are not limited by the above embodiment, but defined by the appended claims and equivalents thereof.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

What is claimed is:

1. A system comprising:
a) a sensor for collecting information regarding the person being in a state of talking or not talking, and providing the information to a signal analyzer;
b) one or more microphone transducers, generating surrounding noise and voice signals to the signal analyzer;
c) the signal analyzer providing the noise and voice signals to a processing unit; and
d) the processing unit providing indications of periods of speech and non-speech based upon the inputs from the sensor and one or more microphones.

2. A system comprising:
a) a sensor collecting voice vibrations and other input from a speaking person;
b) a microphone system, having one or more microphones collecting surrounding noise and voice signals and provide such signals to a combined speech detector;
c) the combined speech detector getting input from the sensor based speech detector and the microphone system and the combined speech detector determines the presence or absence of speech and send a speech or noise determination to a processing system; and
d) the processing system receives input from the microphone system and a speech or noise determination input from the combined speech detector, the input from the microphone system is processed to the speech signal.

3. The system of claim 2 wherein the microphone system and speech detector are integrated into a headset to improve the signal to noise ration of a transmitted signal from the headset.

4. The system of claim 2 with the sensor receiving input from movement of a person's jaw.

5. The system of claim 2 with the sensor receiving input from movement of a person's throat.

6. The system of claim 2 with the sensor receiving input transmitted from facial movement.

7. The system of claim 2 wherein a person's biological vibrations are used to determine periods of speech.

8. The system of claim 2 wherein a person's face vibrations are used to determine periods of speech.

9. The system of claim 2 wherein a person's jaw vibrations are used to determine periods of speech.

10. The system of claim 2 wherein a person's head vibrations are used to determine periods of speech.

11. The system of claim 2 wherein a person's face vibrations are used to capture speech.

12. The system of claim 2 wherein a person's jaw vibrations are used to capture speech.

13. The system of claim 2 wherein a person's head vibrations are used to capture speech.
